(19) United States
(12) Patent Application Publication
(10) Pub. No.: US 2008/0271568 A1
(43) Pub. Date: Nov. 6, 2008

(54) METHOD AND APPARATUS FOR THE GAS ATOMISATION OF MOLTEN MATERIALS

(75) Inventor: John Joseph Dunkley, Sheffield (GB)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(73) Assignee: ATOMISING SYSTEMS LIMITED, Sheffield (GB)

(21) Appl. No.: 12/060,610

(22) Filed: Apr. 1, 2008

(30) Foreign Application Priority Data
May 1, 2007 (GB) 0708385.0

(51) Int. Cl. B22F 9/06; B28B 1/54

(52) U.S. Cl. 75/338; 425/7; 266/217

(57) ABSTRACT

A method for the gas atomisation of melts comprises delivering of molten material into an atomising vessel (3); impinging the molten material, with a jet of heated atomising gas; and delivering the subsequently solidified, atomised particles of the formerly molten material suspended in the atomising gas to a cyclone (8) for transfer to a receiving vessel (12); wherein gas extracted from the atomising vessel (3) is cooled from its extraction temperature and then at least a proportion of this cooled gas, is re-circulated and re-introduced into the atomising vessel (3). The invention also includes apparatus for carrying out the above defined method.

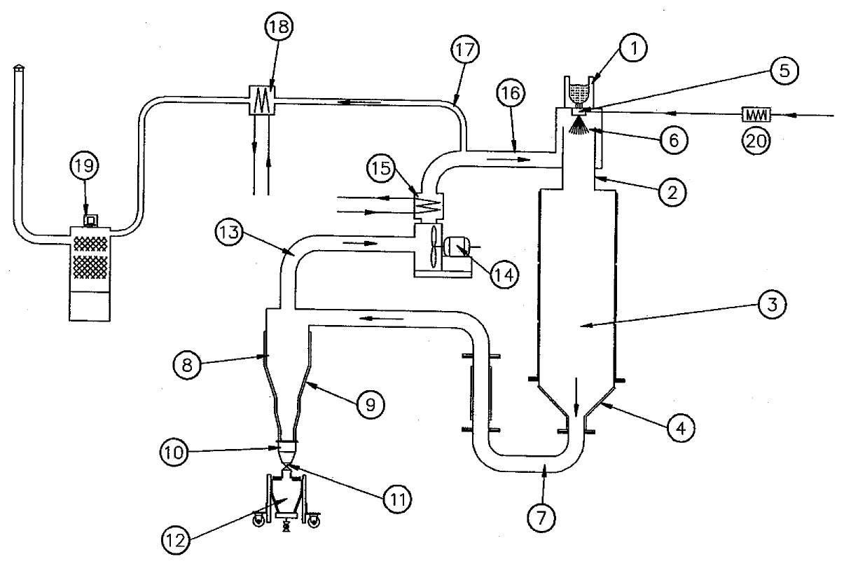

This application claims the benefit of British Application Serial No. 0708385.0 filed May 1, 2007

### FIELD OF THE INVENTION

This invention relates to a method and apparatus for the gas atomisation of molten materials, including metals, with the objective of producing spherical particles of the molten materials, for use in powder metallurgy and other industries.

### BACKGROUND OF THE INVENTION

Gas atomisation of metal melts is in widespread use, for many powder applications, the objective being to obtain, consistently, as near a spherical product as possible, of the smallest size/diameter possible. However, the atomisation process has difficulties, with conventional designs and operational techniques mitigating against achieving these twin objectives, a significant problem being the frequent production of so-called satellited particles which do not exhibit the desired spherical shape, the external surface being interrupted by attached nodules. This problem tends to become worse as finer powders are produced. When attempting to make very fine particles, it is known that heating the atomising gas is helpful. However, the resulting raised powder exit temperatures can have adverse effects on powder quality and make handling of the powder from the atomising vessel difficult.

### OBJECT OF THE INVENTION

A basic object of the invention is the provision of an improved method and apparatus for the gas atomisation of molten materials, including metals.

### SUMMARY OF A FIRST ASPECT OF THE INVENTION

According to a first aspect of the invention, there is provided a method for the gas atomisation of melts comprising:—
delivering of molten material into an atomising vessel;
impinging the molten material, with a jet of heated atomising gas; and
delivering the subsequently solidified, atomised particles of the formerly molten material suspended in the atomising gas to a cyclone for transfer to a receiving vessel; characterised in that gas extracted from the atomising vessel is cooled from its extraction temperature and then at least a proportion of this cooled gas, is re-circulated and re-introduced into the atomising vessel.

### SUMMARY OF A SECOND ASPECT OF THE INVENTION

According to a second aspect of the invention, there is provided apparatus for the gas atomisation of molten material comprising:—
an atomising vessel having an upper inlet end and a lower outlet end;
an atomising nozzle to direct molten material towards, and into, the upper end of the atomising vessel;
means to impinge a jet of heated atomising gas on to or into the molten material;
means to extract subsequently solidified, atomised particles of the formerly molten material suspended in the atomising gas from the lower end of the atomising vessel to convey the suspended particles to a cyclone for separation of the atomised particles from the atomising gas; characterised in that means is provided for cooling the extracted gas to a temperature below its extraction temperature, and in that further means is provided for re-circulating and re-introducing at least a proportion of this cooled gas into the atomising vessel.

### ADVANTAGES OF THE INVENTION

The re-circulating and reintroduction of cooled gas into the atomising vessel has been found to eliminate, or considerably reduce, the production of satellited particles whereby a substantial majority of particles are truly spherical, improving flow and packing properties for the most demanding applications. It is also possible, by the use of (relatively) hot atomising gas, to produce relatively small (e.g. 5-50 microns) particle size—basically a powder—as sought for such applications as High Velocity Oxy-Fuel (HVOF) and plasma spraying, and Metal Injection Moulding (MIM). Furthermore, these fine powders are delivered from the apparatus at low temperatures, typically <100° C., despite the use of hot gas for atomisation.

The use of re-circulated and re-introduced gas not only allows the production of relatively fine powder, if that is the requirement, but allows significant reductions in gas consumption, if a coarser powder is required, allowing major savings in operating costs.

A further advantage of hot gas atomisation is in the atomisation of non-metallic melts, especially glassy or viscous materials such as silicates, borates, etc. If processed with relatively cold atomising gas these form fibres, but the use of hot gas allows spherical powders to be produced.

A further advantage of hot gas atomisation is that the removal of heat which occurs conventionally by the use of cold atomising gas from the conventionally provided nozzle for the melt is much reduced, allowing reliable operation of smaller nozzles without freezing, thereby allowing high gas/melt ratios to be used and yet finer powders to be made.

### PREFERRED OR OPTIONAL METHOD FEATURES OF THE INVENTION

The re-circulated and re-introduced gas is used at temperatures in the range 50° C. to 200° C. in the atomisation zone of the atomising vessel.

The re-circulated and re-introduced gas is used at temperatures of 50° C. to 100° C.

The atomising gas is heated to temperatures preferably in the range of 400° C. to 1000° C.

The flow rate of re-circulated and re-introduced cooled gas is more than double the flow rate of the atomising gas, preferably 5-20 times this flow rate.

### PREFERRED OR OPTIONAL APPARATUS FEATURES OF THE INVENTION

The means for re-circulating and re-introducing cooled gas includes a recirculation unit including a fan.

An outlet conduit for the atomised particle suspended in the atomising gas extends from a lower end of the atomising vessel to an inlet of the cyclone.

The cyclone is water cooled e.g. by being provided with a water jacket supplied with water from a coolant circuit.

The cyclone serves to deliver the separated atomised particles to a hopper and then to a collecting pot.

A conduit from the cyclone serves to convey cooled gas exiting from the cyclone, either via a supplementary cooling unit or via a circulation fan, if provided, directly to the atomising vessel.

The supplementary cooling unit includes a heat exchanger with circulating cooling water therein.

A cooled gas reintroduction conduit, downstream of the re-circulation unit and any cooling unit, extends to the atomising zone at the upper end of the atomising vessel.

A nitrogen extraction conduit is connected to the reintroduction conduit, to convey surplus cooled gas to atmosphere or to a recycling system (optionally via a fine filter), after passage through a cooler.

### DRAWINGS

One example of apparatus in accordance with the second aspect for carrying out the method of the first aspect is shown in the accompanying drawings.

A tundish 1 adapted to contain molten metal etc to be atomised, is located above an upper, inlet end 2 of an atomising vessel 3, the latter having a lower outlet end 4 for the discharge of solidified, atomised particles suspended in an atomising gas. In the conventional manner, molten metal is supplied from the tundish 1 to an atomising nozzle 5 located above an atomisation zone 6 of the vessel 3, molten material issuing from the nozzle 5 being impinged upon by the atomising gas, in the atomisation zone 6, the atomising gas having been heated by heater 20 to 400° C. to 1000° C.

From the lower, outlet end 4 of the atomising vessel 3 extends an outlet conduit 7 for conveying the atomised particles, still suspended in the atomising gas, to a cyclone 8, which is provided with a water cooling jacket 9 having a coolant circulation system (not shown), the cyclone 8 serving, in the conventional manner, to separate the atomised particles from the atomising gas and also acting as a substantial heat removal means, with the particles gravitating towards a hopper 10 from which they are discharged, at intervals, by opening a valve 11 into a receiving vessel in the form of a collecting pot 12 for subsequent transport and processing.

A conduit 13 serves to convey away from the cyclone 8 gas that has been cooled by the cyclone, for which conveyance purpose a circulation fan 14 is associated with the conduit 13. Should it be required to cool the gas further, then a heat exchanger 15 may similarly be associated with the conduit 16. In accordance with the invention, at least a proportion (possibly 50% to 95%, preferably 70% to 90%) of the hot gas exiting from the cyclone 8 having been cooled by the cyclone 8 e.g. to a temperature of 50° C. to 200° C., is then re-introduced into the atomising vessel 3 along a gas re-introduction conduit 16 downstream of the fan 14, and any heat exchanger 15. The conduit 16 conducts cooled, re-circulating gas back to the atomising zone 5. Surplus gas from the cyclone is extracted from the system via a nitrogen extraction conduit 17 branching from the conduit 16 to convey surplus gas to atmosphere via a cooler 18 and assisted by an extraction fan and filter 19.

1. A method for the gas atomisation of melts comprising:—
delivering of molten material into an atomising vessel;
impinging the molten material, with a jet of heated atomising gas; and
delivering the subsequently solidified, atomised particles of the formerly molten material suspended in the atomising gas to a cyclone for transfer to a receiving vessel; characterised in that gas extracted from the atomising vessel is cooled from its extraction temperature and then at least a proportion of this cooled gas, is re-circulated and re-introduced into the atomising vessel.

2. A method as claimed in claim 1, wherein the re-circulated and re-introduced cooled gas is re-introduced at temperatures in the range 50° C. to 200° C.

3. A method as claimed in claim 2, wherein the re-circulated and re-introduced cooled gas is used at temperatures of 50° C. to 100° C.

4. A method as claimed in claim 1, wherein the atomising gas is heated to temperatures in the range of 400° C. to 1000° C.

5. A method as claimed in claim 1, wherein the flow rate of recirculated and re-introduced cooled gas is more than double the flow rate of the atomising gas.

6. A method as claimed in claim 5, wherein the flow rate of re-circulated and re-introduced cooled gas is 5-20 times the flow rate of the atomising gas.

7. Apparatus for the gas atomisation of molten material comprising:—
an atomising vessel having an upper inlet end and a lower outlet end;
an atomising nozzle to direct molten material towards, and into, the upper end of the atomising vessel;
means to impinge a jet of heated atomising gas on to or into the molten material;
means to extract subsequently solidified, atomised particles of the formerly molten material suspended in the atomising gas from the lower end of the atomising vessel to convey the suspended particles to a cyclone for separation of the atomised particles from the atomising gas; characterised in that means is provided for cooling the extracted gas to a temperature below its extraction temperature, and in that further means is provided for re-circulating and re-introducing at least a proportion of this cooled gas into the atomising vessel.

8. Apparatus as claimed in claim 7, wherein the means for re-circulating and re-introducing the cooled gas includes a recirculation unit including a fan.

9. Apparatus as claimed in claim 7, wherein an outlet conduit for the atomised particles suspended in the atomising gas extends from a lower end of the atomising vessel to an inlet of the cyclone.

10. Apparatus as claimed in claims 7, wherein the cyclone is water cooled.

11. Apparatus as claimed in claim 10, wherein the cyclone is provided with a water jacket supplied with water from a coolant circuit.

12. Apparatus as claimed in claim 7, wherein the cyclone serves to deliver the separated atomised particles to a hopper and then to a collecting pot.

13. Apparatus as claimed in claim 7, wherein a conduit from the cyclone serves to convey cooled gas exiting from the cyclone, either via a supplementary cooling unit or via a circulation fan, if provided, directly to the atomising vessel.

14. Apparatus as claimed in claim 13, wherein the cooling unit includes a heat exchanger with circulating cooling water therein.

15. Apparatus as claimed in claim 8, wherein a cooled gas reintroduction conduit, downstream of the re-circulation unit and any cooling unit, extends to the atomising zone at the upper end of the atomising vessel.

16. Apparatus as claimed in claim 15, wherein a nitrogen extraction conduit is connected to the reintroduction conduit, to convey surplus cooled gas to atmosphere or to a recycling system (optionally via a fine filter), after passage through a cooler.
